(19) United States
(12) Patent Application Publication
(10) Pub. No.: US 2002/0063520 A1
(43) Pub. Date: May 30, 2002

(54) Pre-formed fluorescent plate - LED device

(76) Inventors: Huei-Che Yu, Hsinchu City (TW); Yen-Cheng Chen, Hsinchu Hsien (TW); Kuo-Hsin Huang, Hsinchu City (TW); Sheng-Bang Huang, Chang-Hua Hsien (TW); Jyh-Jong Luo, Hsinchu City (TW)

Correspondence Address: Jason Z. Lin, 19597 Via Monte Drive, Saratoga, CA, 95070, US

(21) Appl. No.: 09/726,678

(22) Filed: Nov. 29, 2000

(51) Int. Cl. H01J 1/62

(52) U.S. Cl. 313/512

(57) ABSTRACT

An LED device has a light emitting chip covered by a pre-formed fluorescent plate for emitting white light. The light emitting chip is located in a chip holder. The pre-formed fluorescent plate is positioned above the light emitting chip and supported by the chip holder. Transparent resin is used to seal the void formed between the chip holder and the pre-formed fluorescent plate. Because the thickness and flatness of the pre-formed fluorescent plate can be easily controlled, white light emitted from the LED device has high quality as well as good uniformity.

### BACKGROUND OF THE INVENTION

1. Field of the Invention

The present invention relates to an innovative structure of light emitting diodes, and more particularly to a structure of a pre-formed fluorescent plate that has more uniform thickness and flatness than the conventional fluorescent layer of an LED.

2. Description of the Related Art

At present, a blue light emitting diode (LED) may be combined with a layer of fluorescent material to create an LED device for emitting white light. Essentially, a combination of red, green and blue light appears as white light. By using a conventional light emitting diode, it is possible to produce blue light of certain intensity. After this blue light passes through the fluorescent material that contains phosphor, part of the blue light is absorbed by the phosphor which emits red and green light. The combination of red, green and the residual blue light produces intense light that appears as white light.

The thickness of the fluorescent layer and the flatness of its surface are important factors that determine the uniformity, stability, intensity and quality of the combined white light of the above-mentioned LED device. If the layer of the fluorescent material is too thick or too thin, the color of the combined light becomes yellowish or bluish accordingly. In addition, if the surface of the fluorescent layer is too rough, the intensity of the combined light is reduced and the light quality degrades. Therefore, it is important that the fluorescent layer have appropriate thickness as well as very smooth surface so that white and high intensity light with good quality can be emitted.

In U.S. Pat. No. 5,998,925, dated Dec. 7, 1999, Nichia introduces an LED having a nitride compound semiconductor and a YAG phosphor as shown in FIG. 1. The structure of the conventional white light LED lamp of FIG. 1 comprises a first lead frame 11 including a cup 10 as a reflector, a second lead frame 12, two bonding wires 20, 21, a light-emitting chip 30 and a fluorescent layer 50. The bonding wires 20, 21 connect the cathode and anode of the light-emitting chip 30 to the lead frames 11, 12 respectively. The fluorescent material is disposed over the light-emitting chip 30 and the cup 10 to form a phosphor layer. Generally, the fluorescent material is a transparent resin contains phosphor. When the light-emitting chip 30 is activated by a DC current at an appropriate forward voltage, it emits blue light of which part is absorbed by the phosphor to emit yellow light. The emitted light appears white because of the combination of the blue and yellow light.

Nichia's art has the drawback that the thickness of the fluorescent layer can not be well controlled. As show in FIG. 1, the combined light passing through the direction of arrow 60 appears white. The combined light passing through the direction of arrow 61 and arrow 62, however, appears bluish and yellowish respectively. If the combined light is projected to a sheet of white paper, it appears as a bright and white core surrounded by three annual rings with different colors, i.e., a yellow annular ring, a blue annular ring, and another yellow annular ring on the surface of the white paper.

In U.S. Pat. No. 5,959,316, dated Sep. 28, 1999, HP introduces a multiple encapsulation of Phosphor-LED device as shown in FIG. 2. In general, this kind of LED device is the same as FIG. 1 except that an extra transparent layer 40 is disposed between the fluorescent layer 51 and the light-emitting chip 30. The thickness of the fluorescent layer 51 is, therefore, more uniform than that of FIG. 1. Nevertheless, the interface between the transparent layer 40 and the fluorescent layer 51 is not flat. The surface of the fluorescent layer 51 is not flat either. The light ray is perturbed when the blue light passes through the interface between the transparent layer 40 and the fluorescent layer 51 as well as the surface of the fluorescent layer 51. Consequently, the light is scattered, refracted and reflected. The light intensity is reduced and its quality degraded. The thickness of the fluorescent layer is also not uniform because the areas 70, 71 are thicker and rougher than the other areas. As show in FIG. 2, the combined light is reflected by the rough surface of the fluorescent layer through the direction of arrows 63. The combined light is also scattered and reflected by the rough interface between the transparent resin and the fluorescent layer.

As discussed above, the LED has the problem of poor flatness in the fluorescent layer. When applying the transparent resin and fluorescent layers to the light emitting diode, it is hard to control the flatness of the transparent resin and fluorescent layers. Consequently, the surface of the transparent layer and the surface of fluorescent layer are not flat and smooth due to the surface tension. More specifically, the surfaces of the transparent resin and fluorescent layers that are close to the inner edge of the cup and the wire are rough and sloping. When light passes through those areas, it is scattered. As usual, it also has the problem that the thickness of the fluorescent layer near the inner edge of the cup and the wire is thicker than the other area. Similarly to the LED of FIG. 1, light also appears in different colors after passing through different areas of different thickness. The above problems occur both in LED devices of lamp type and surface-mount type.

### SUMMARY OF THE INVENTION

The present invention has been made to overcome the drawbacks of a conventional LED device with fluorescent material. The primary object of this invention is to provide an LED device that emits uniform white light with high intensity. Accordingly a pre-formed fluorescent plate with uniform thickness and smooth surfaces is disposed above a light emitting chip of the LED device. Part of the light emitted by the light emitting chip is absorbed by the phosphor contained in the fluorescent plate to emit light of different colors. The combined light becomes white light travelling through the pre-formed fluorescent plate uniformly along a desired direction.

According to the invention, the innovative structure of the LED device comprises a chip holder having a cavity for holding a light emitting chip. The surface of the cavity also serves as a light reflector. A pre-formed fluorescent plate is disposed above the light emitting chip and supported by the chip holder. The gap between the pre-formed fluorescent plate and the light emitting chip is sealed with transparent resin. The pre-formed fluorescent plate is substantially flat and its surface can be made flat, convex or concave to adjust the direction of the emitted light.

It is also an object of the invention to provide an LED device that emits white light and is easy to manufacture. The pre-formed fluorescent plate of this invention can be formed by applying a thin fluorescent layer on the surface of a glass plate. The thickness and smoothness of the pre-formed fluorescent plate can be easily controlled.

It is yet another object of the invention to provide an LED device with an UV protective layer. By disposing an UV protective layer over the pre-formed fluorescent plate, the LED devices can be protected from UV light. The lifetime of the LED device can be increased. A further object of the invention is to provide a color filter for the LED device to improve the purity of the white light.

The foregoing and other objects, features, aspects and advantages of the present invention will become more apparent from a careful reading of a detailed description provided herein below, with appropriate reference to the accompanying drawings.

### BRIEF DESCRIPTION OF THE DRAWINGS

FIG. 1 is a cross-section of a conventional LED structure.

FIG. 2 is a cross-section of another conventional LED structure.

FIG. 3 is a side view of the LED device with a pre-formed fluorescent plate of the present invention.

FIG. 4 is a cross-section of the LED device with a pre-formed fluorescent plate of the present invention.

FIG. 5 is a cross-section of a surface-mount LED device with a pre-formed fluorescent cap of the present invention.

FIG. 6 shows cross-sections of the pre-formed fluorescent layer that is formed with different surfaces and shapes.

FIG. 7 is a cross-section of the LED device with an UV protective layer and a color filter disposed over and under the pre-formed fluorescent plate of the present invention.

FIG. 8 is a cross-section of the LED device with a pre-formed fluorescent plate enclosed by a light collecting cup according to the invention.

### DETAILED DESCRIPTION OF THE PREFERRED EMBODIMENTS

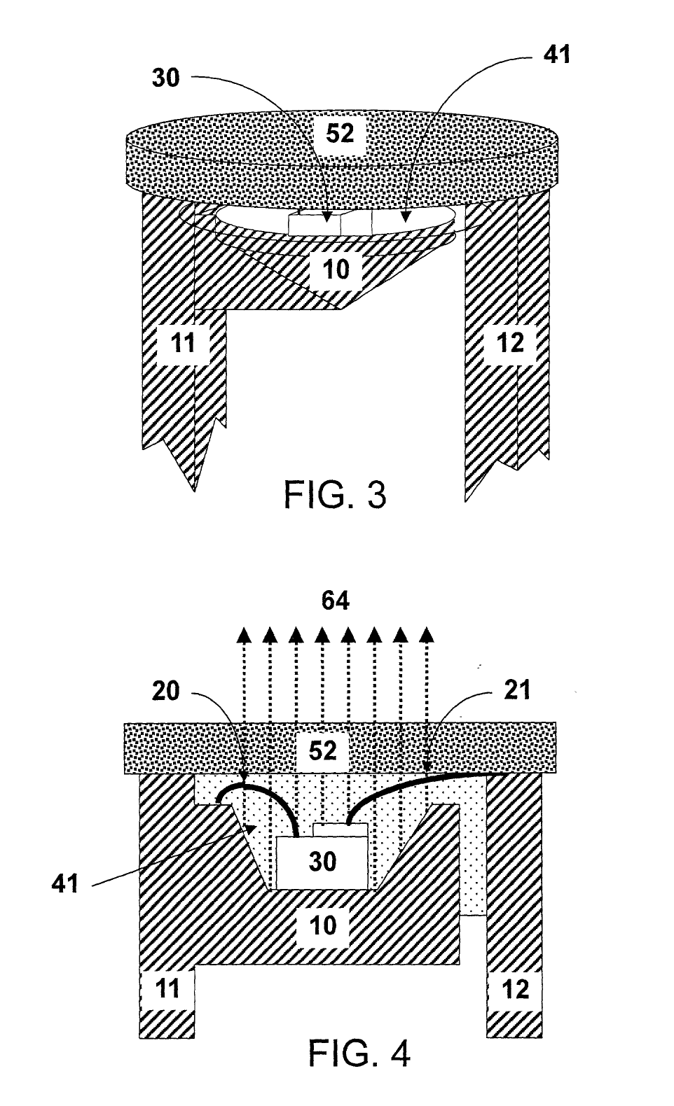

Refer to FIG. 3, the innovative structure of the LED device of the present invention with a pre-formed fluorescent plate is shown. The structure of the LED device comprises a first lead frame 11 having a cup 10 as a reflector, a second lead frame 12, two bonding wires 20, 21, a light emitting chip 30, and a pre-formed fluorescent plate 52. Parts similar to the prior art are identified with the same numbers. The pre-formed fluorescent plate 52 is supported by the lead frames 11, 12 that also form a chip holder for holding the light emitting chip 30. The gap between the fluorescent plate 52 and the light-emitting chip 30 is sealed with transparent resin 41.

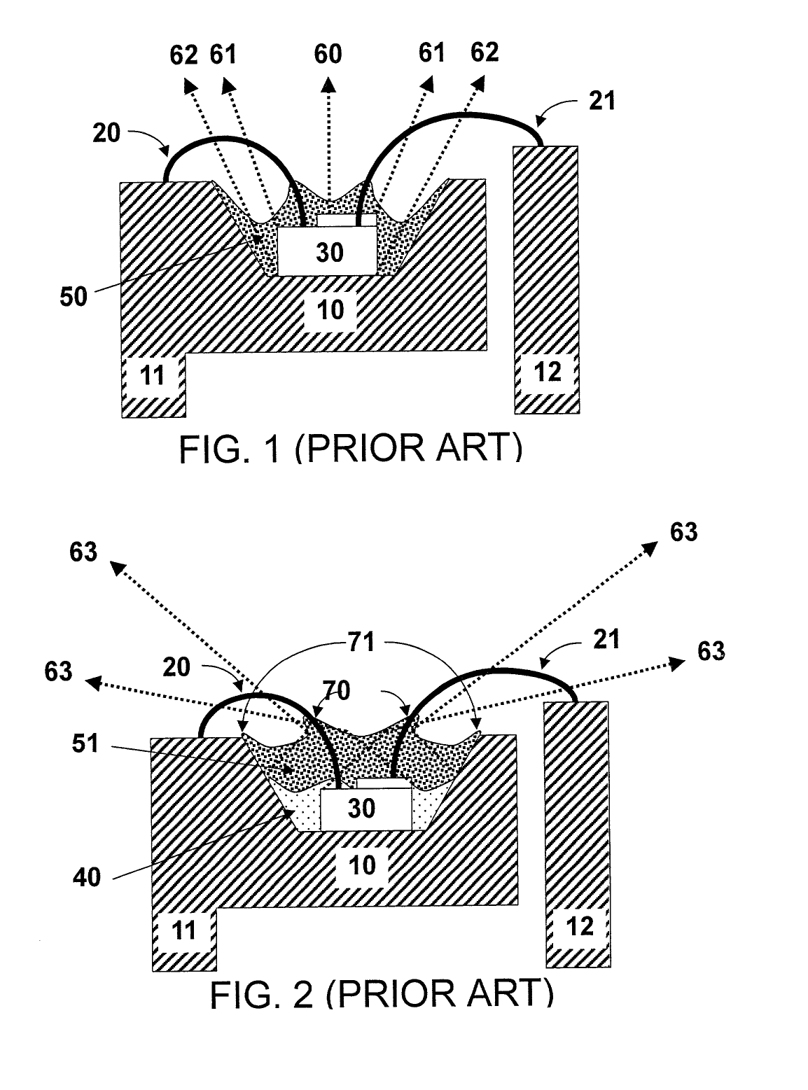

The emitted light is reflected and collected uniformly from the light emitting chip 30. The combined light then passes through the pre-formed fluorescent plate 52 along the direction of the arrows 64 shown in FIG. 4. If the combined light of the LED device is projected onto a sheet of white paper, it appears more uniform than the light emitted by a conventional LED device of FIG. 1 or FIG. 2.

The pre-formed fluorescent plate 52 of this invention comprises fluorescent material that is transparent. When light of a certain wavelength is absorbed by the phosphor in the fluorescent material, light of a different wavelength is emitted. The pre-formed fluorescent plate may be formed by applying a thin fluorescent layer on the surface of a glass plate. The pre-formed fluorescent plate 52 is bonded to the lead frames 11, 12 by the transparent resin 41. The void formed by the pre-formed fluorescent plate 52 and the lead frames 11, 12 may be filled with resin 41. The resin may be applied only to the edge of the pre-formed fluorescent plate 52 and the edge of the lead frames.

FIG. 4 shows a cross-section of the LED device with a pre-formed fluorescent plate 52 of this invention. It can be seen that the thickness of the fluorescent plate 52 is made very uniform and the interface between the fluorescent plate 52 and the resin layer 41 is also smooth. Therefore, the LED device of this invention emits white light with better quality, uniformity and intensity than the conventional LED device. The flatness and thickness of the pre-formed fluorescent plate 52 are also easier to control as compared to the conventional LED device.

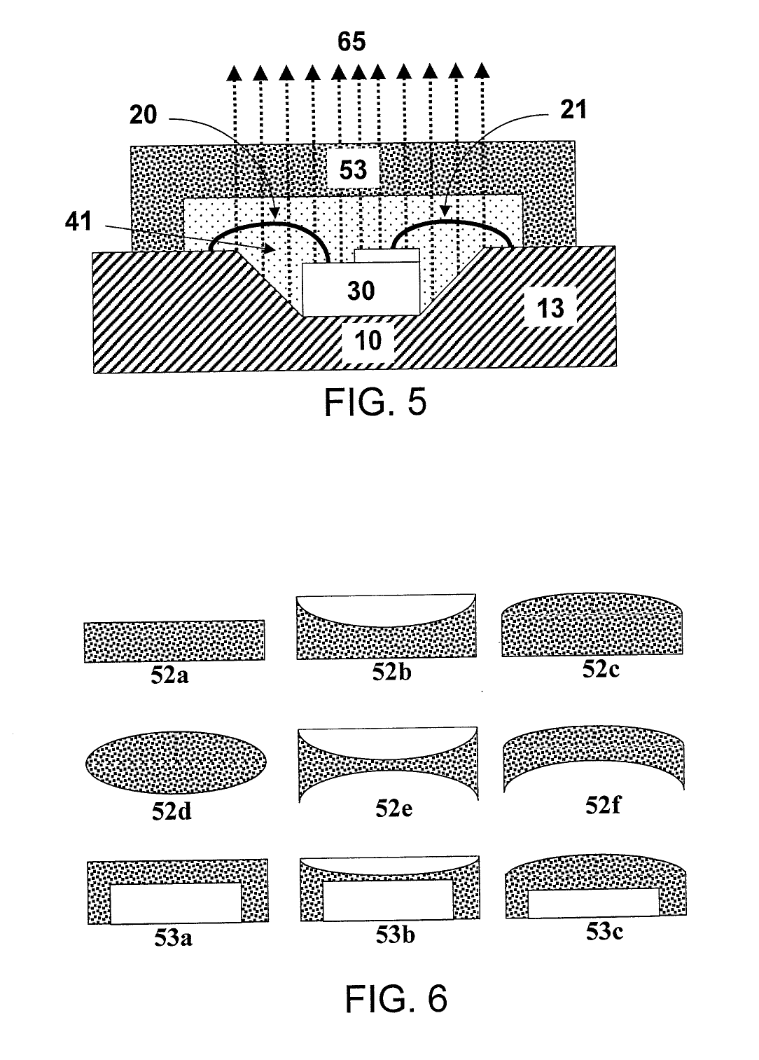

FIG. 5 shows a cross-section of another embodiment of the LED device according to the invention. The LED device is a surface-mount LED device. The structure comprises a surface-mount holder 13 including a cup 14 as a reflector, two bonding wires 20, 21, a light-emitting chip 30, and a pre-formed fluorescent cap 53. It can be seen that the thickness of the pre-formed fluorescent cap 53 is made very uniform and the inner side as well as the outside of the fluorescent cap 53 are also smooth.

For the same reason as in the structure of FIG. 3, the emitted light is collected and reflected by the cup 10 from the light emitting chip 30. The combined light then passes through the pre-ferred fluorescent cap 53 along the direction of the arrows 65 shown in FIG. 5. If the combined light of the LED device is projected onto a sheet of white paper, it appears more uniform than the light emitted by a conventional LED device because the thickness and flatness of the pre-formed fluorescent cap 53 are more uniform.

The pre-formed fluorescent plate 52 and fluorescent cap 53 may be formed in various shapes to adjust the angle and intensity of the combined light. FIG. 6 shows some examples. A typical pre-formed fluorescent plate 52a has flat surfaces on both sides. The pre-formed fluorescent plate 52b has a concave surface on one side. The pre-formed fluorescent plate 52c has a convex surface on one side. The pre-formed fluorescent plate 52d has convex surfaces on both sides of the fluorescent plate. The pre-formed fluorescent plate 52e has concave surfaced on both sides. The pre-formed fluorescent plate 52f combines a convex surface with a concave surface. A typical pre-formed fluorescent cap 53a has flat surfaces. The pre-formed fluorescent cap 53b has a concave upper surface. The pre-formed fluorescent cap 53c has a convex upper surface.

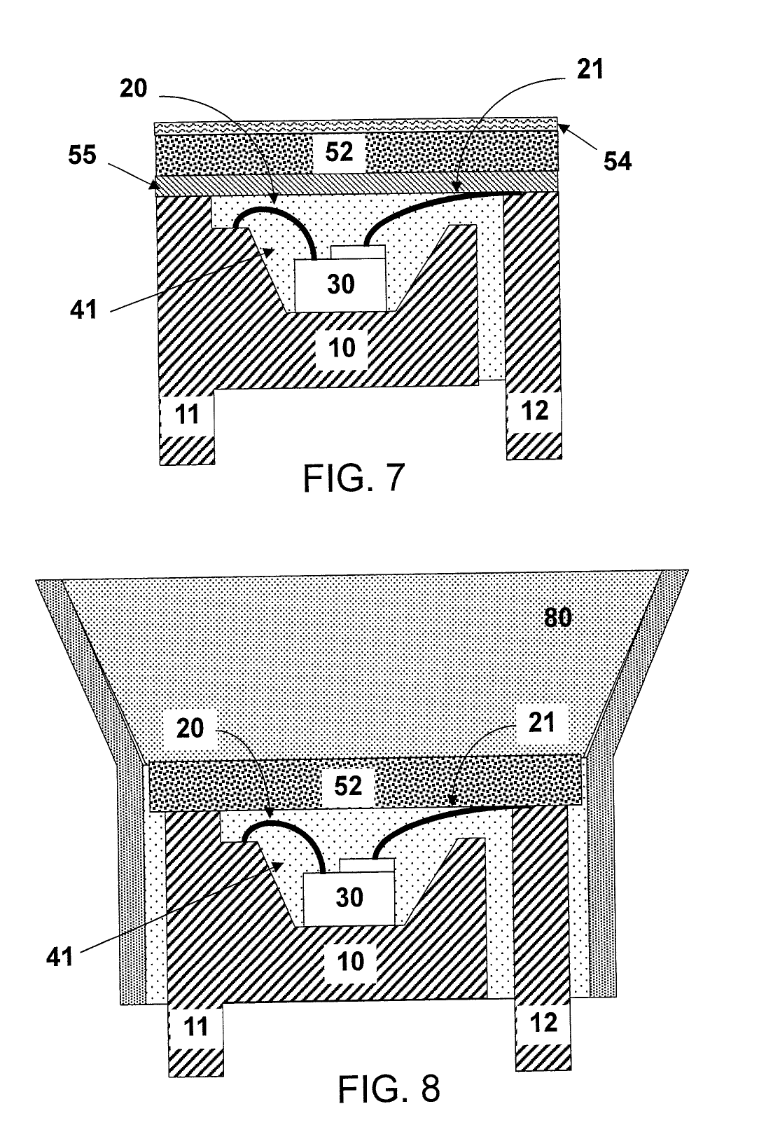

According to this invention, an UV protective layer and a color filter layer can be added to the LED device. FIG. 7 shows the cross-section of the LED device of the present invention that includes an UV protective layer 54 and a color filter layer 55. The UV protective layer 54 contains anti-UV light material that can absorb UV light. The lifetime of the LED device is increased because the fluorescent material is protected by the anti-UV layer. The color filter layer 55 improves the purity of the emitted light before it is absorbed by the fluorescent layer 52.

To enhance the intensity and adjust the angle of the combined light, a light collecting cup can also be added to the LED device. FIG. 8 shows the cross-section of the LED device with a light collecting cup 80. The main function of the light collecting cup 80 is to increase the intensity of the combined light because the light can be reflected and focused by the light collecting cup 80.

Although only the preferred embodiments of this invention were shown and described in the above description, numerous changes in the detailed construction and combination as well as arrangement of parts may be restored to without departing from the spirit or scope of the invention as hereinafter set forth in the appended claims. It is requested that any modification or combination that comes within the spirit of this invention be protected.

What is claimed is:

1. A light emitting device comprising;
a chip holder having a cavity;
a light emitting chip located in said cavity;
a pre-formed fluorescent plate positioned above said light-emitting chip and supported by said chip holder;
wherein a void is formed between said pre-formed fluorescent plate and said chip holder, said void being sealed with transparent resin.

2. The light emitting device as claimed in claim 1, said chip holder being formed with a lamp type.

3. The light emitting device as claimed in claim 1, said chip holder being a surface-mount chip holder.

4. The light emitting device as claimed in claim 1, said pre-formed fluorescent plate comprising fluorescent material and transparent resin.

5. The light emitting device as claimed in claim 1, wherein said transparent resin is applied only around the edge of said pre-formed fluorescent plate for bonding said pre-formed fluorescent plate to said chip holder.

6. The light-emitting device as claimed in claim 1, further having a light collecting cup enclosing said pre-formed fluorescent plate.

7. The light emitting device as claimed in claim 1, wherein said pre-formed fluorescent plate has upper and lower surfaces each being formed as a flat, convex or concave surface.

8. The light emitting device as claimed in claim 1, said pre-formed fluorescent layer having an UV protective layer.

9. The light-emitting device as claimed in claim 1, said pre-formed fluorescent layer having a color filter layer.

10. A light emitting device comprising;
a chip holder having a cavity;
a light emitting chip located in said cavity;
a pre-formed fluorescent cap positioned above said light-emitting chip and supported by said chip holder, said pre-formed fluorescent cap being substantially flat with an edge extending down;
wherein a void is formed between said pre-formed fluorescent cap and said chip holder, said void being sealed with transparent resin.

11. The light emitting device as claimed in claim 10, said chip holder being formed with a lamp type.

12. The light emitting device as claimed in claim 10, said chip holder being a surface-mount chip holder.

13. The light emitting device as claimed in claim 10, said pre-formed fluorescent cap comprising fluorescent material and transparent resin.

14. The light emitting device as claimed in claim 10, wherein said transparent resin is applied only around the edge of said pre-formed fluorescent cap for bonding said pre-formed fluorescent cap to said chip holder.

15. The light-emitting device as claimed in claim 10, further having a light collecting cup enclosing said pre-formed fluorescent cap.

16. The light emitting device as claimed in claim 10, wherein said pre-formed fluorescent cap has an upper surface being formed as a flat, convex or concave surface.

17. The light emitting device as claimed in claim 10, further having an UV protective layer disposed over an outer surface of said pre-formed fluorescent cap.

18. The light-emitting device as claimed in claim 10, further having a color filter layer disposed beneath an inner surface of said pre-formed fluorescent cap.
